(19) United States
(12) Patent Application Publication
(10) Pub. No.: US 2006/0090186 A1
(43) Pub. Date: Apr. 27, 2006

(54) Programming content capturing and processing system and method

(76) Inventors: Bryan D. Santangelo, Superior, CO (US); Zhongming Chen, Erie, CO (US); Craig Mahonchak, Superior, CO (US); Steve E. Riedl, Superior, CO (US); Amanuel Bereketab, Boulder, CO (US)

Correspondence Address: ALEX L. YIP;KAYE SCHOLER LLP, 425 PARK AVENUE, NEW YORK, NY, 10022, US

(21) Appl. No.: 10/970,429

(22) Filed: Oct. 21, 2004

(51) Int. Cl. H04N 7/173

(52) U.S. Cl. 725/87; 725/91

(57) ABSTRACT

A method and system is provided for processing a program stream for interactive viewing, wherein the program stream includes programming content relating to a program having a plurality of program segments. The program stream is received and divided into at least one block comprising an expanse of the program stream. In accordance with an embodiment of the invention, a block is measured based upon the normal play time of the programming content, or some other predefined measurement. A determination is then made as to whether the block comprises at least one complete program segment. In accordance with an embodiment of the invention, a program segment is a logical portion of TV show or movie, such as a specific story of a news show, a scene in a movie, etc. Upon identifying one or more programming segments, these segment(s) may be made available for interactive viewing prior to receiving the end of the program. In another embodiment of the invention, a determination is made as to whether the block comprises an ending portion—but incomplete portion—of a program segment. In such instance, segment portions from multiple blocks may be accessed and appended to form a complete segment which may then be made available for interactive viewing. In yet another embodiment of the invention, content derived from blocks associated with a program segment may be combined with additional content relating to the program segment, even though the additional content is not within the plurality of blocks.

### FIELD OF THE INVENTION

The invention relates to communications systems and methods, and more particularly to a system and method for processing multimedia content for storage and retrieval in a broadband communications network.

### BACKGROUND OF THE INVENTION

With the advent of interactive programming services—e.g., video-on-demand (VOD)—viewers are presented with the opportunity to access a wide array of programming content at a time desired by the user. For example, on-demand services allow a user to view a listing of available movies and TV shows and request that a selected movie or TV show be transmitted to the user at the user's request. In addition, many interactive programming services allow a user to perform trick mode functions, e.g., manipulating the presentation of a movie or TV show, including rewinding, fast-forwarding and pausing of the transmitted content.

As interactive programming services have become more ubiquitous, users' expectations to interactively access and manipulate movie and TV show presentations at the users' behest have increased. For example, many users that subscribe to interactive programming services expect that previously broadcast TV shows and movies will typically be made available for access—including playback and manipulation—by such users.

It has therefore become desirable that programming content be made available on-demand to users with little delay from the time that programming content is originally broadcast or otherwise made available.

### SUMMARY OF THE INVENTION

Availability of such interactive programming content, however, is limited by the amount of time required for processing such content for access by users of interactive programming services. For example, a service provider typically needs to encode programming content in a certain manner in order to enable such content to be accessed by a user of an interactive programming service. Encoding programming code so that it may be accessed for interactive viewing is often performed after a service provider captures an entire TV show or movie—only then is the TV show or movie available for access by interactive programming service users. The time to encode programming content (including time to receive the complete program)—particularly live broadcast programs—can cause a significant delay in making interactive programming content available to such users.

Thus, in accordance with aspects of the present invention, a technique is implemented to effectively reduce the amount of time between when programming content is originally acquired and when such content may be made available for interactive viewing. Thus, a method and system is provided for processing a program stream for interactive viewing, wherein the program stream includes at least one program having a plurality of program segments. The program stream is received and divided into blocks. In accordance with an embodiment of the invention, a block is measured based upon the normal play time of the programming content. Hence, a block may be, for example, twenty minutes of programming content at normal play time. In another embodiment of the invention, some other predefined measurement of a block may be implemented, such as the amount of programming content that is received between a starting Universal Time Coordinated (UTC) time and an ending UTC time.

One or more blocks relating to a selected program segment is then identified. In accordance with an embodiment of the invention, a program segment is a logical portion of TV show or movie, such as a specific story of a news show, a scene in a movie, etc. Upon identifying one or more programming segments from the blocks, these segment(s) are-made available for interactive viewing. In accordance with an embodiment of the invention, the segments are made available for interactive viewing prior to receiving the end of the program.

In addition, a determination may be made as to whether a block comprises an ending portion—but incomplete portion—of a program segment. In such instance, segment portions from multiple blocks may be combined to form a complete segment which may then be made available for interactive viewing. In yet another embodiment of the invention, content derived from blocks associated with a program segment may be combined with additional content relating to the program segment, even though the additional content is not within the plurality of blocks.

### BRIEF DESCRIPTION OF THE DRAWINGS

FIG. 1A illustrates a sequence of television programs for presentation to users;

FIG. 1B illustrates a sequence of the television programs of FIG. 1A that are block-divided and made available as one or more segments, in accordance with an embodiment of the invention;

FIGS. 2A to 2F are graphical user interfaces used for identifying program segments available to users, in accordance with an embodiment of the invention;

FIG. 3 is a block diagram of a communications system in accordance, with an embodiment of the invention;

FIG. 4A is a table which illustrates contents of a segment metadata file associated with programming content, in accordance with an embodiment of the invention;

FIG. 4B is a table which illustrates a program file having file content and a filename, in accordance with an embodiment of the invention;

FIG. 5 is a flowchart depicting a process for compiling programming content, in accordance with an embodiment of the invention;

FIG. 6 is a flowchart depicting a process for availing programming content to users as one or more segments, in accordance with an embodiment of the invention;

FIG. 7 illustrates a request for recorded program material from a set-top terminal in the system of FIG. 3;

FIG. 8 is a flow chart depicting a process for providing recorded program material in response to the request of FIG. 7;

FIG. 9 illustrates selected carriers for transmitting recorded program materials in a forward passband of the system of FIG. 3;

FIG. 10 is a flow chart depicting a process for pausing a recorded program in response to a pause message from a set-top terminal;

FIG. 11 is a flow chart depicting a process for rewinding a recorded program in response to a rewind message from a set-top terminal; and

FIG. 12 is a flow chart depicting a process for fast-forwarding a recorded program in response to a fast-forward message from a set-top terminal.

### DETAILED DESCRIPTION

In accordance with aspects of the present invention, a technique is implemented to effectively receive streaming multimedia content in digital form, and block-divide and compile the received content for effective storage of such programming content and for effectively providing access to such content by users of an interactive programming service through which the content is made available.

The inventive technique facilitates, among other things: dividing and capturing programming content of a received programming stream, determining whether the captured programming content should be processed to avail to users interactive services associated with the programming content, and compiling the divided programming content for effectively providing to users interactive services regarding such programming content. Thus, by dividing the programming content into manageable sized blocks, processing the content contained within such blocks is facilitated. For example, locating and availing to a user a desired portion of a program may be expedited and/or require less processing resources when blocks containing a portion of a program are handled, as compared with handling an entire program to process the desired portion.

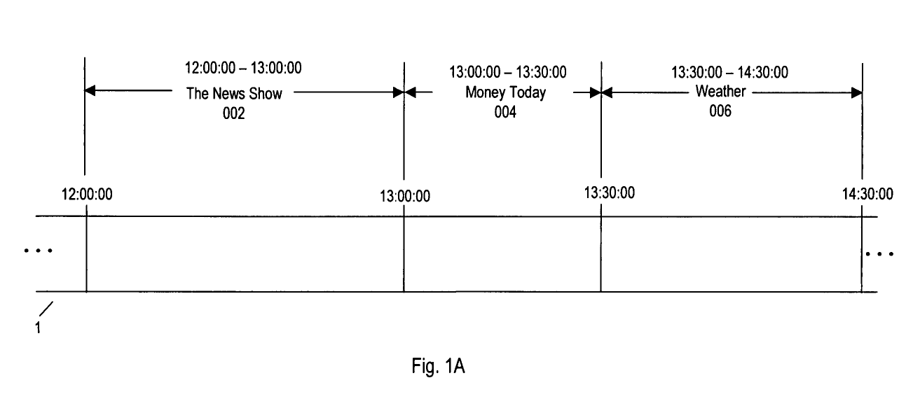

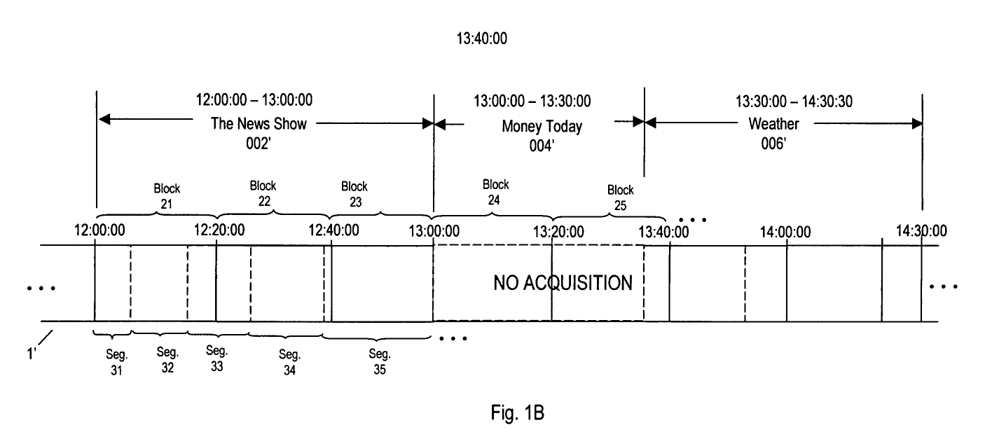

FIG. 1A illustrates a sequence (denoted 1) of TV programs 002, 004 and 006, accessible via a given program channel, which spans from 12:00:00 to 14:30:00 (Universal Time Coordinated (UTC)). By way of example, program 002 is entitled “The News Show” and spans from 12:00:00 to 13:00:00, program 004 is entitled “Money Today” and spans from 13:00:00 to 13:30:00 and program 006 is entitled “Weather” and spans from 13:30:00 to 14:30:00. When a user tunes into the program channel that carries programs 002, 004 and 006 during the time that such programming is broadcast, the user may view one or more of these programs. In addition, in circumstances where interactive programming service is available, the user may have the opportunity to view one or more of these programs “on-demand” after one or more of these programs is broadcast.

In prior art, where a user has access to interactive programming services, interactive viewing for a given program may be made available to the user after the given program is broadcast. In other words, in prior art, a movie or TV show, for example, is made available on-demand after the movie or TV show is completely recorded by a cable service provider, such as Time Warner Cable. Thus, suppose The News Show 002 illustrated in FIG. 1A is broadcast as a real-time program, such as a live news show. With a conventional interactive program service, The News Show 002 may be made available as an on-demand program after the complete show has aired—i.e., some time after 13:00:00. In addition, if programs 004 and 006 were real-time programs, these shows could be made available on-demand at some time after 13:30:00 and 14:30:00, respectively.

However, in accordance with an embodiment of the invention, when a user tunes into a given program channel, the user may view: (1) the program that is being broadcast when the user tunes into the given channel, (2) an interactive service program that is offered to the user, if the user is accessing an interactive programming service, or (3) a segment (e.g., a specific story, scene or commercial) of an interactive service program that is offered to the user, if the user is accessing an interactive programming service incorporating the inventive techniques described herein.

Referring to FIG. 1B for illustrating an embodiment of the invention, a sequence (denoted 1′) of TV programs 002′, 004′ and 006′ is illustrated, in accordance with an embodiment of the invention, which spans from 12:00:00 to 14:30:00. Program 002′ is entitled “The News Show” and spans from 12:00:00 to 13:00:00, program 004′ is entitled “Money Today” and spans from 13:00:00 to 13:30:00 and program 006′ is entitled “Weather” and spans from 13:30:00 to 14:30:00. In accordance with the embodiment of the invention, programming content may be made available to users as one or more segments, wherein each of these segment(s) relates to a portion of the programming content and is typically logical in nature, in that the each segment relates to a certain scene or story of the movie or TV show. For example, The News Show 002′ comprises five segments—segment 31, segment 32, segment 33, segment 34 and segment 35—wherein, in this example, each of these segments relates to a different news story of The News Show 002′. As will be described below, some of these segments may be accessed by an interactive programming service even though the program comprising these segments has yet to be completely recorded by the service provider transmitting the program or by some other entity involved in developing or transmitting the programming content.

In some instances, authorization for making programming content available by segments may be withheld. An example of where a program may not be acquired for compiling into segments is illustrated by the shaded portion of FIG. 1B which relates to the Money Today program 004′. If, for example, the content provider does not provide authorization for one or more of its shows to be made available as segments, the content provider may provide instructions that such program not be acquired for segmenting. In accordance with an alternative embodiment of the invention, a program is only acquired for the provision of segments when the content provider includes an instruction for such segmenting.

In addition to the provision of segments, FIG. 1B shows programs 002′, 004′ and 006′ divided into multiple blocks—i.e., block 21, block 22, block 23, block 24 and block 25. In accordance with an embodiment of the invention, each block comprises programming content for a predetermined period of time. For example, referring to FIG. 1B, each block comprises twenty minutes worth of programming content at, for example, normal play time. Thus, block 21 refers to the first twenty minutes of The News Show 002′, block 22 refers to the second twenty minutes of The News Show 002′, block 3 refers to the final twenty minutes of The News Show 002′, block 4 refers to the first twenty minutes of Money Today and block 5 refers to the final ten minutes of Money Today 004′ and the first ten minutes of Weather 006′. It should be noted that, in one embodiment of the invention, the programming content is divided into blocks even when no acquisition rights are provided. It should also be noted that, although FIGS. 1A and 1B illustrate programs that begin exactly on the hour or half hour, e.g., 12:00:00, 13:00:00 and 13:30:00, and blocks that begin exactly at 12:00:00, 12:20:00, 12:40:00, etc., programs and blocks may not necessarily begin at such rounded times. For example, a program may begin at 12:01:02 (or some other time), and the beginning time for the first complete block of such program may begin at 12:08:51 (or some other time during the program's broadcast).

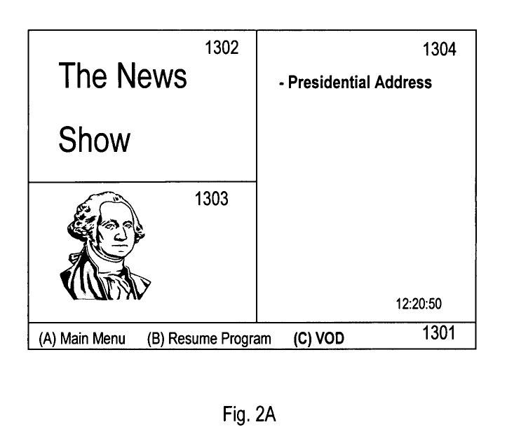

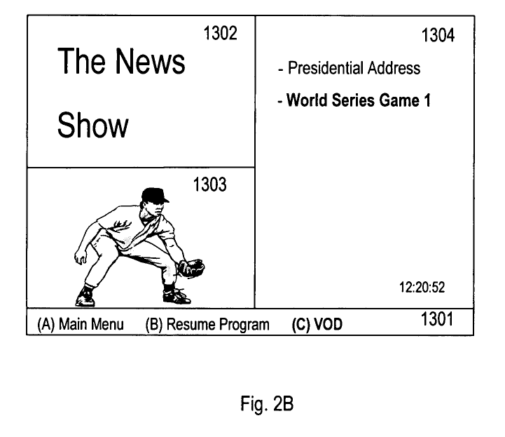

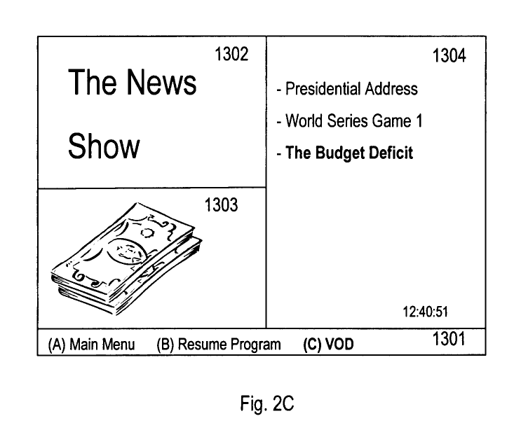

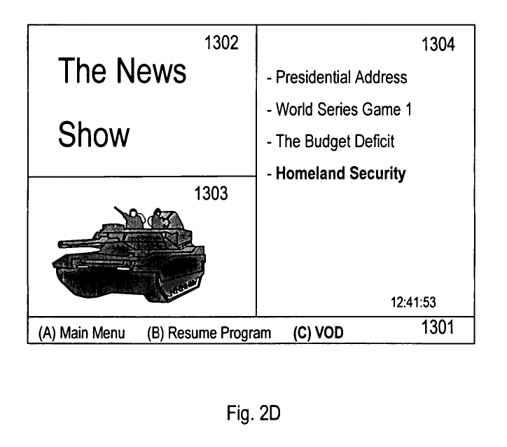

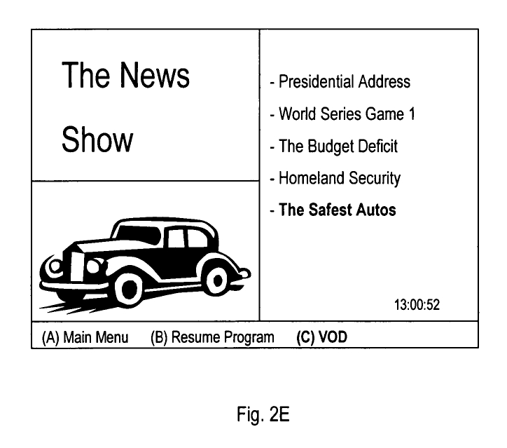

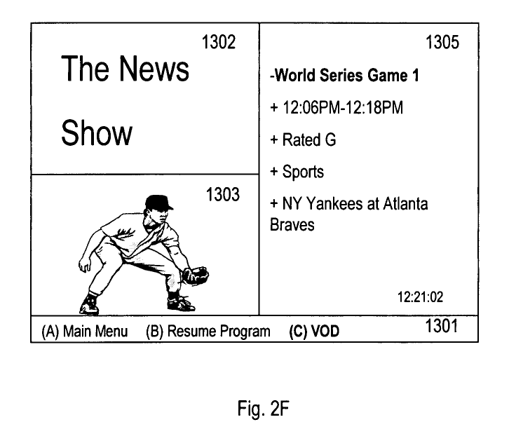

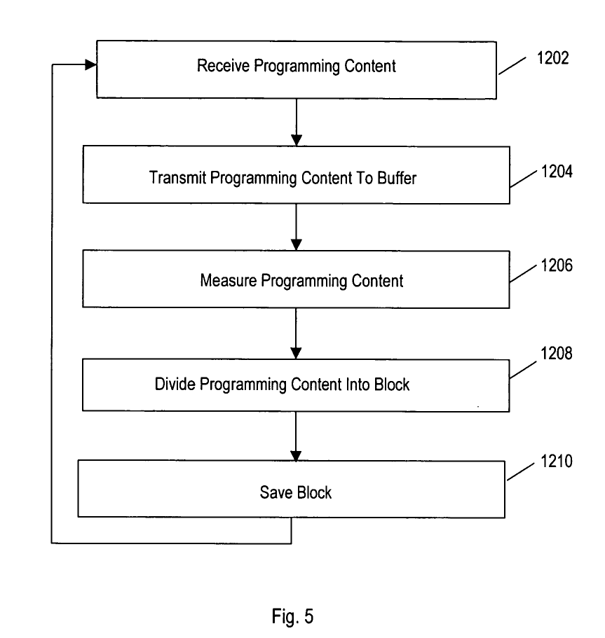

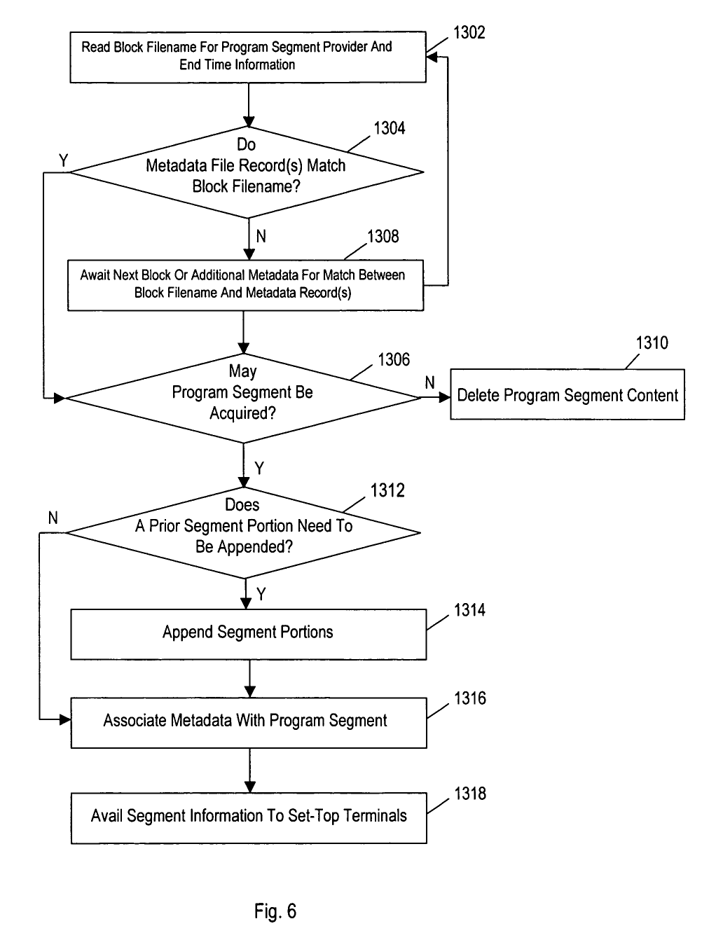

As will be described more fully below with reference to FIGS. 5 and 6, programming content is divided into blocks, which may then be compiled such that program segments may be made available to users of interactive programming services even though, in many instances, the program containing these segments and more has not been completely recorded or broadcast. This inventive concept will now be described with reference to the graphical user interfaces (GUIs) of FIGS. 2A to 2F and the programming content representation of FIG. 1B. It should be noted that programs that have not been completely recorded or broadcast may be, for example, “live” or “initial broadcast” programs. Live programs are those programs that are being broadcast at the same time, or substantially the same time, that it they are originally recorded—e.g., a live sports broadcast, such as The World Series. Initial broadcast programs are those programs that have been previously broadcast, but that which have not been previously broadcast—e.g., the first broadcast of an episode of the TV show Friends.

As illustrated by FIG. 1B, a live broadcast program, entitled The News Show 002′, is being broadcast from 12:00:00 to 13:00:00 and comprises five segments 31 to 35. In this example, these segments relate to five stories provided by the News Show 002′—stories entitled: (1) Presidential Address, (2) World Series Game 1, (3) The Budget Deficit, (4) Homeland Security and (5) The Safest Autos. In accordance with an embodiment of the invention, an interactive program service is made available to users such that any of these five stories may be accessible to the user after the entire show has been broadcast (i.e., after 13:00:00), or a subset of these stories may be accessible starting at various times after The News Show 002′ begins broadcast but before such broadcast ends.

For example, the first two segments of The News Show 002′ (Segment 31 and 32)—containing the stories entitled, “Presidential Address” and “World Series Game 1”—have already been broadcast when block 21 is formed at 12:20:00. Thus, in accordance with an aspect of the invention, these two stories could be made available in theory at 12:20:00, taking into account the block processing time, even though live broadcast of The News Show 002′ has not ended at that time, and the complete show has yet to be recorded by the service provider. Referring to FIG. 2A, a GUI is provided which informs a user that, at 12:20:50 (the present viewing time), the Presidential Address story of The News Show program is available for interactive viewing by a user of, for example, a video-on-demand (VOD) service. In this example, the GUI of FIG. 2A identifies the program title (e.g., The News Show) in a title box 1302, a scene from a story of The News Show in scene box 1303 and the story or stories available to the user in story menu 1304. An optional control bar 1301 may be included which allows the user to select among (A) a Main Menu which provides user options (such as access to electronic program guide (EPG) data, music content, Internet access, etc.), (B) a Resume Program command which allows the user to view normal broadcast programming of a selected channel, or (C) a VOD command which allows the user to access the VOD service—such as the service displayed in FIGS. 2A to 2F.

As described above, a second complete story—entitled “World Series Game 1”—is also included in block 21. Because block 21 was formed at 12:20:00, “World Series Game 1” is also made available for interactive viewing at a time shortly after 12:20:00, such as in this instance 12:20:52—as shown in the GUI of FIG. 2B. Similar to the GUI of FIG. 2A, the GUI of FIG. 2B comprises control bar 1301, title box 1302, scene box 1303 and story menu 1304. As shown by the GUI of FIG. 2B (by, e.g., the highlighted (or bold-faced) selections), the user has selected a channel that offers VOD services for the TV show entitled “The News Show,” has access to the stories entitled “Presidential Address” and “World Series Game 1,” and highlighted (for possible VOD selection) the World Series Games 1 story. Because the user highlighted the World Series Game 1 program (indicated here by boldface) in story menu 1304, scene box 1303 in this example displays a scene from that story.

The next block of programming 1′—block 22—comprises, among other things, the remaining portion of segment 33—which relates to the story entitled “The Budget Deficit”—and complete segment 34—which relates to the story entitled “Homeland Security.” Because these stories (segments) are completed within block 22 which was captured at 12:40:00, these stories may be made available for interactive viewing at a time shortly after 12:40:00. Thus, referring to the GUI's of FIGS. 2C and 2D which, like the GUIs of FIGS. 2A and 2B, include control bar 1301, title box 1302, scene box 1303 and story menu 1304, by at least 12:40:51 The Budget Deficit story and the prior stories of The News Show were made available to VOD users, and by at least 12:41:53 the Homeland Security story and the prior stories of The News Show were made available to VOD users.

At a time shortly after 13:00:00—when Block 23 which comprises the remaining portion of segment 35 (which relates to the final story of The News Show entitled “The Safest Autos”) is captured—a VOD user may have access to all of the stories of the News Show, as illustrated by the GUI of FIG. 2E.

FIG. 2F illustrates a GUI that is available to VOD users when, in accordance with an embodiment of the invention, a segment or story provided in story menu 1304 of FIG. 2B is highlighted for selection. For example, suppose a VOD user accesses the GUI of FIG. 2B and highlights the “World Series Game 1,” another GUI is displayed—such as the GUI illustrated by FIG. 2F—which provides information relating to the selected story. Thus, in this example, information regarding the World Series Game 1 story is provided in story menu description 1305 and includes the time that this story was originally broadcast, the rating of the story, the subject matter of the story and a description of the story.

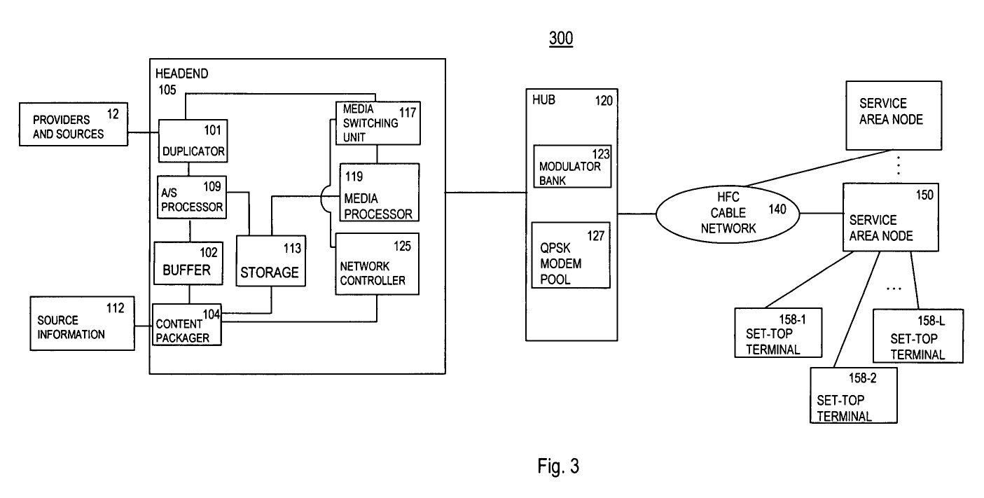

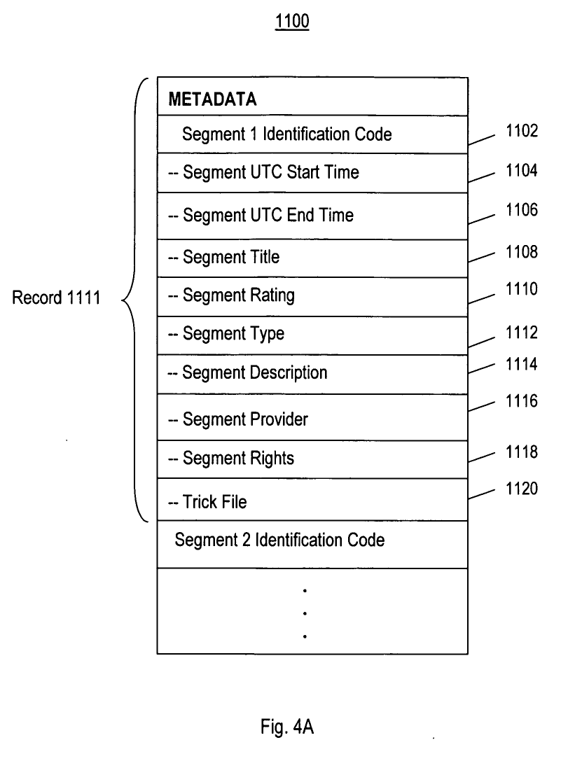

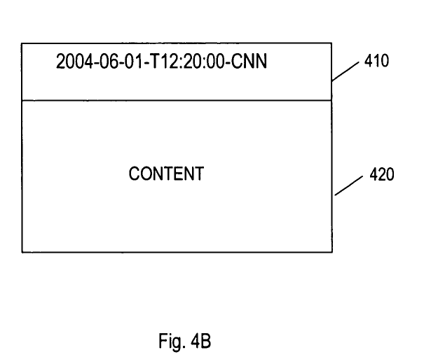

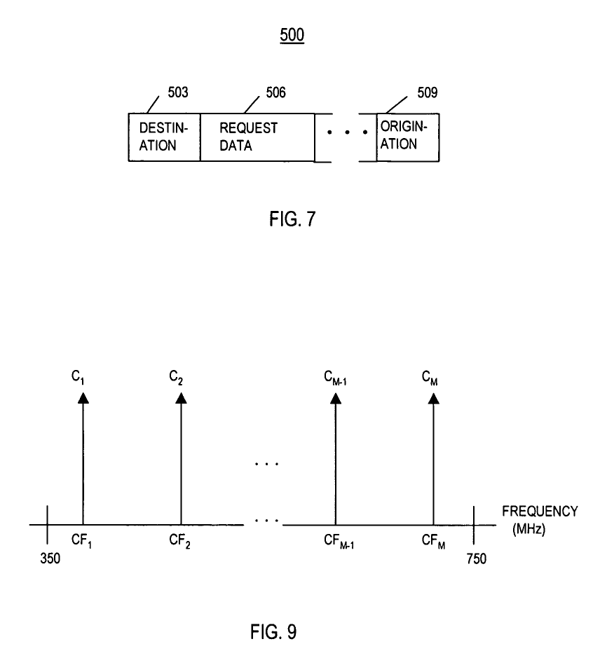

A description of the broadband communications system that provides an interactive programming service to users and that enables the block-dividing of programming content as well as making such programming content available as one or more segments is described below with reference to FIG. 3. In addition, the description below with reference to FIGS. 4A to 6 describe the processes for block-dividing and availing such programming content as segments. Moreover, the description provided below with reference to FIGS. 7 to 12 below describe various aspects of the system illustrated in FIG. 3, including the mechanism of processing programming content so that it can be accessed for interactive viewing and for the system's handling of interactive viewing commands initiated by a user.

### The Broadband Communications System

FIG. 3 illustrates broadband communications system 300, embodying the principles of the invention. System 300, among other things, receives programming content, records the programming content, divides the programming content into block, makes programming content of one or more blocks available as segments, provides interactive programming and services to users, and receives and processes commands from users for accessing and manipulating one or more program segments.

For example, system 300 in this instance includes a cable system for delivering, in accordance with the invention, information and entertainment programs to set-top terminals on the user premises. As shown in FIG. 3, system 300 includes headend 105, hub 120, hybrid fiber coax (HFC) cable network 140 and different service area nodes including node 150, which in this instance is connected to set-top terminals 158-1 through 158-L in a neighborhood, where L represents an integer.

Headend 105 receives programs and services from various providers and sources, e.g., analog and digital satellite sources, application servers, media servers, the Internet, etc. Analog and digital satellite sources typically provide the traditional forms of television broadcast programs and information services. Application servers typically provide executable code and data for application specific services such as database services, network management services, transactional electronic commerce services, system administration console services, application specific services (such as stock ticker, sports ticker, weather and interactive program guide data), resource management service, connection management services, subscriber cares services, billing services, operation system services, and object management services. Media servers provide time-critical media assets such as MPEG-2 encoded video and audio, MPEG-2 encoded still images, bit-mapped graphic images, PCM digital audio, three dimensional graphic objects, application programs, application data files, etc. Although specific examples of programs and services which may be provided by the aforementioned sources are given herein, other programs and services may also be provided by these or other sources without departing from the spirit and scope of the invention.

### Receiving Programming Content and Availing Segments to Users

Duplicator 101 in headend 105 receives programming materials including, e.g., TV program streams, from one or more of the aforementioned sources. Duplicator 101 allows the received content to be copied in circumstances where received content is to be forwarded downstream through media switching unit 117 for availability (i.e., broadcast) to set-top terminals 158-1 to 158-L and to be further processed by headend 105 for, among other things, the block-dividing of programming content and the provision of interactive programming service regarding program segments. If the content is only being broadcast (and no further processing of the received content is required), duplication is not necessary; the program stream is passed on to media switching unit 117 for downstream transmission. Alternatively, if the received content is not being broadcast, but needs processing for subsequent availability (to, e.g., interactive service users), then duplicator 101 need not forward the content to media switching unit 117; rather the received program stream can be forwarded to acquisition/staging (A/S) processor 109 for processing.

A/S processor 109 in headend 105 processes program materials in analog and digital forms. Analog TV program streams may be formatted according to the National Television Standards Committee (NTSC) or phase alternating line (PAL) broadcast standard. Digital TV streams may be formatted according to the Digital Satellite System (DSS), Digital Broadcast Services (DBS), or Advanced Television Standards Committee (ATSC) standard. Thus, programming content as well as associated data (such as metadata) is carried by the program stream. Processor 109, among other things, extracts programming content in the analog and digital TV streams and reformats the content to form one or more MPEG-2 encoded transport streams. Such reformatting may even be applied to those received streams already in an MPEG-2 format. This stems from the fact that the digital content in the received MPEG-2 streams are typically encoded at a variable bit rate (VBR). To avoid data burstiness, processor 109 in a conventional manner re-encodes such digital content at a constant bit rate (CBR) to form the aforementioned transport streams.

An MPEG-2 transport stream contains multiple program streams with different video and audio feeds multiplexed for transmission through the same transmission channel. The program streams representing individual programs are identified by respective program identifications (IDs) within a transport stream. It should be noted at this point that the term “transmission channel” should not be confused with a “program channel.” A “transmission channel” signifies a designated frequency band through which a transport stream is transmitted. On the other hand, a “program channel” signifies the source of the program material selected by a user to view. For example, a user may select program channel 2 to view broadcast program material provided by CBS; program channel 14 to view broadcast program material provided by ESPN; program channel 32 to view broadcast program material provided by MTV, etc.

In this illustrative embodiment, the transmission channels, each carrying a transport stream, may be 6 MHz bands populating a forward passband, e.g., 350 to 750 MHz band, of a coaxial cable, which is allocated for downstream communication from headend 105 to a set-top terminal.

A/S processor 109 may receive, for example, live and initial broadcast programming content, including movie videos, news reports, sports events, etc. from content providers. In addition to the raw content, program metadata (not to be confused with MPEG-2 metadata) is also a part of programming content that describes characteristics of the program. For example, program metadata may describe attributes that are inherent in the content of the program, such as the rating, starting time, ending time, program type, etc. relating to the program. In addition to program metadata, programming content may comprise segment metadata. The segment metadata associated with programming content segment is described more fully below with respect to FIG. 4A.

FIG. 1B illustrates a representation of programming content which is divided into temporal-based blocks and made available as logic-based segments. In this illustrative embodiment, programming content concerning a program includes a program metadata file and trick files associated with the program, in addition to the programming content contained in a transport stream. In FIG. 1B, The News Show 002′ spans from 12:00:00 to 13:00:00. The News Show 002′, in this instance, is a program that comprises five stories or segments—e.g., segments 31 to 35. The blocks described with reference to FIG. 1B, however, relate to a time-based block-dividing (e.g., twenty minutes of programming content) and the aforementioned segments are formed by some logical division of programming content such as by story, scene or the like—illustrated here as a segment.

Let's assume that The News Show 002′ in this instance is a live broadcast program. A/S processor 109, among other things, collects in a database (not shown) program guide data associated with different TV programs which are not initial broadcast (including in this instance The News Show 002′) from an application server, which may be different from the sources of the TV programs themselves, such as source information 112. Each program when presented to A/S processor 109 is identified by a program designation, which may be used to locate the corresponding program guide data. In particular, A/S processor 109, while processing The News Show 002′, may locate the corresponding program guide data from source information 112 to create in real time the program metadata file associated with The News Show 002′. The program metadata file thus created includes such data as the title, rating (e.g., G, PG-13, R, etc.), names of the producer, director, and actors, duration of the program, program type (e.g., situation comedy), etc. It should be noted that the program metadata described above should not be confused with the segment metadata described below with reference to FIG. 4A and which is used for availing programming content as segments and to provide information about programming content segments in particular, in accordance with an aspect of the invention.

A/S processor 109 may also create, in real time, trick files associated with a program (such as The News Show 002′) or program segment (such as segment 31 of The News Show 002′) which are used to perform trick mode functions (e.g., rewinding and fast-forwarding) on The News Show 002′ or segments thereof, in accordance with the invention. One such trick file in this instance is a “fast-forward” trick file which contains an array of identifiers of I-frames in the program stream (MPEG-2 encoded as mentioned before) corresponding to The News Show 002′ (or its segments) in a forward direction. Another trick file is a “rewind” trick file which contains an array of identifiers of I-frames in the program stream corresponding to The News Show 002′ (or its segments) in the reverse direction. The I-frame identifiers in the trick files are used as indices or markers for rewinding and fast-forwarding The News Show 002′. It should be noted that not all of the I-frames associated with The News Show 002′ are selected for the trick files. Rather, the I-frames are selected periodically along the program stream. Thus, the shorter the period is, the closer the instants from which The News Show 002′, or segments thereof, can be rewound, and to which program The News Show 002′ can be fast-forwarded, thereby achieving finer adjustments.

A/S processor 109 stores the live or initial broadcast programming content including the program metadata file and trick files associated with a program according to its program designation in storage 113. In accordance with an embodiment of the invention, programming content may first be divided into blocks and then made available as segments, wherein these segments contain segment metadata associated thereto. The process for availing programming content in the form of one or more segments is described below with reference to FIGS. 4A to 6.

### Block-Dividing Programming Content and Availing Segments to Users

The description provided above with reference to FIG. 3 addresses the processing of programming content upon its receipt by A/S processor 109 so that such programming content can be accessed for interactive viewing by users. In addition, in accordance with an embodiment of the invention, received programming content may be divided into blocks (e.g., twenty minute blocks of content) by A/S processor 109, such that segments (completed stories or scenes of a program, commercial(s), etc.) within these blocks may be identified by content packager 104 and made available to users of interactive programming services at a time after such segment identification, and in instances, prior to recording or broadcast of an entire program. Thus, in accordance with an embodiment of the invention, programming content that is stored by storage 113 may, in many instances, comprises program segments having additional metadata information (i.e., segment metadata information) associated thereto.

In accordance with an embodiment of the invention, segments are identified and processed by using segment metadata associated with received programming content which is stored one or more blocks. A representation of segment metadata is described below with reference to FIG. 4A, and a representation of a file storing content (including associated metadata) related to a block is described below with reference to FIG. 4B. In another embodiment of the invention, segmentation messages or cues (also known as cue tones in analog program streams) may be used for identifying programs that are to be processed into one or more segments. Segmentation messages comprise data which serves as an indicator of the beginning and ending of, e.g., a program or a segment. Employing such segmentation messages to identify and form segments is fully described in U.S. application Ser. No. 10/428,719, filed on May 1, 2003, and is incorporated herein by reference. In accordance with an embodiment of the invention, segmentation messages may contain origin identification information which, as described below, may be used to identify specific programs received from providers and sources 12 and to associate segment metadata thereto.

The process of dividing programming content into blocks and then availing such content as segments is described with reference to FIGS. 5 and 6.

### Segment Metadata File

In accordance with an embodiment of the invention, segment metadata (i.e., data that describes or relates to programming content segments) is provided by source information 112 and may be received by content packager 104 for temporary storage and access.

FIG. 4A illustrates a representation of various data types that are stored in segment metadata file 1100 to be associated with, in accordance with an embodiment of the invention, segments of a television program (e.g., The News Show 002′). For example, metadata record 1111 of segment metadata file 1100 contains an identification code for a given program segment (such as Segment 1 Identification Code 1102). Referring to FIGS. 1B and 2A, Segment 31 relates to the Presidential Address story of The News Show 002′, and therefore Segment 1 Identification Code 1102, in this example, serves as an identifier for identifying the Presidential Address story.

File 1100 also includes information relating to the UTC start time 1104 and UTC end time 1106 of the program segment which may be derived from an external source such as human tagggers which are employed to monitor programming content that is broadcast, associate actual start and end times with program segments upon viewing such content, and record the actual start and end times of program segments.

It should be appreciated that automated techniques for monitoring the actual start and end times of a program may be used instead. For example, one such automated technique may involve automatic processing of the broadcast signals to detect fade-to-black frames typically surrounding the beginning and end of a program segment (such as a transition from a TV show to commercial, from commercial to another commercial, from one TV show story or scene to another, and the like).

The segment metadata of file 1100 may also comprise segment title information 1108, segment rating information 1110 (e.g., G, PG-13, R, etc.), segment type 1112 (e.g., situation comedy, sports ), segment description information 1114, segment provider information 1116 (e.g., NBC, CNN), segment rights 1118 (whether content acquisition is authorized) and trick file information 1120 (i.e., the name and location of the trick file(s) associated with the segment).

As described more fully below, segment data is associated with its corresponding program segment for segment processing performed by content packager 104, in accordance with the invention. As such, programming content may be made available to users as segments, in accordance, e.g., with the process described with reference to FIG. 6, and may be manipulated by users having interactive programming services.

### Dividing Programming Content Into Blocks

FIG. 5 illustrates the process for dividing received programming content into blocks. In accordance with an embodiment of the invention, a block comprises programming content having a normal play time (NPT) of predetermined length. For example, referring to FIG. 1B, each block comprises twenty minutes of programming content corresponding to twenty minutes of NPT, although the predetermined amount of programming content that makes up a block may be increased or decreased. The purpose of forming blocks is to capture programming content that is a subset of one or more programs so that such block-divided and captured content, or a portion thereof (e.g., a segment), can be made available for interactive viewing, in some instances, before the end of the broadcast of the entire program of which the segment is a part.

Thus, at step 1202, programming content is received by duplicator 101 of headend 105. As described above, in certain circumstance, duplicator 101 makes a copy of the received programming content—for example, when the received programming content is to be broadcast upon receipt by headend 105 and a copy of the program stream is to be processed for subsequent interactive viewing as described herein.

Duplicator 101 then forwards the program stream (or a copy thereof) to A/S processor 109 which, as described above, processes the content upon receipt such that the content may be encoded, when permitted, for access by users of an interactive programming service. A/S processor 109 is also configured, in accordance with an embodiment of the invention, to forward such programming content to buffer 102 of headend 105 (step 1204) and is responsible for measuring (step 1206) the amount of programming content it has received for the formation of, in this case, blocks of twenty minutes of content play time. In accordance with an embodiment of the invention, A/S processor 109 may be configured to monitor for the transmission of twenty minutes of content to buffer 102 by reading normal play time data that is received with the programming content. Monitoring for a new twenty minute block takes place each time a previous twenty minute block is formed.

When programming content of a predetermined amount (e.g., twenty minutes) is received by A/S processor 109 and forwarded to buffer 102, processor 109 sends an instruction to buffer 102 to release the stored content, thereby dividing the received stream into a block (step 1208). In response to this instruction, the block of programming content is transmitted to and stored by content packager 104 (step 1210), where the block is given a block filename.

A diagram of a block stored as a file is illustrated in FIG. 4B and comprises programming content 420 and a filename 410. In accordance with an embodiment of the invention, block filename 410 is descriptive in that it includes date, time and content provider information. For example, if The News Show 002′ is broadcast by CNN on Jun. 1, 2004 and the block relates to programming content that is broadcast between 12:00:00 and 12:20:00, the filename 410 maybe: “CNN-2004-06-01-T12:20:00.” Thus, filename 410 contains the date and end time that the programming content of this channel was broadcast as well as the name of the content provider. In accordance with an embodiment of the invention, a given block is stored by content packager 104 without further processing thereto until the programming content that forms one or more block is made available to users as one or more segments (or discarded if, for example, acquisition rights are not authorized, or if no segments are requested within a predetermined time after a block is formed). The process of availing programming content as segments is described below with reference to FIG. 6.

### Availing Programming Content as Segments

Upon creating a file containing a block of programming content, content packager 104 determines whether the programming content should be made available as one or more segments. Packaging programming content into one or more segments so that they are available to users for viewing typically occurs when a first request for such segment(s) are made by a user. In accordance with an embodiment of the invention, content packager 104 accomplishes this by reading a block filename for the program segment service provider and end time information (step 1302), and then searching the data stored within its segment metadata file(s) to determine whether the created block contains programming content that may make up a complete segment or the ending portion of a segment.

In so doing, content packager 104 reads the block's filename 410—which identifies (1) the programming content provider name and (2) the block end time—and determines whether any of the records of the segment metadata file, such a s record 1111 of metadata file 1100, have data that match the content provider name found in the block's filename 410 and a segment end time that is earlier in time than the block end time which is also found in the block's filename 410 (step 1304).

In some instances, there may be no such match between the block filename and one or more metadata records. This may occur if, for example, the block stored by content packager 104 does not contain programming content that makes up the end of a segment. For example, a twenty minute block may include programming content relating to the middle twenty minutes of a forty minute segment. In such instance, the block does not contain programming content that makes up the end of the segment. Only when a subsequent block—containing the ending portion of this forty minute segment—is received is the end of the segment available and then ready to form a complete segment with programming content from the prior block.

If content packager 104 finds a match between a segment metadata record and the block filename, content packager 104 determines (as described below) whether it is authorized to make the content available as a segment (step 1306). If, however, content packager 104 does not find a match between a segment metadata record and the block filename, content packager 104 awaits receipt of subsequent block(s) until a match is found (step 1308)—at which point content packager 104 will determine whether it is authorized to make the content available as one or more segments (step 1306).

Content packager 104 determines whether it is authorized to make content available as one or more segments by reading the segment rights metadata field 1118 associated with the content. If field 1118 indicates that no such authorization is provided, then the programming content to be made available as one or more segments is deleted from the block (step 1310). If, however, segment rights metadata field 1118 indicates the authorization to make such programming content available as one or more segments, then content packager 104 determines whether the current block being processed contains the entire content for the segment being created or if a segment portion or portions from a previously created block or blocks need to be appended with an ending segment portion contained by the block being processed (step 1312). By identifying the start time of a given segment and comparing that start time with the end time provided by the filename of a previously received block, such determination may be made.

For example, suppose content packager 104 is instructed to make available as one or more segments Jun. 1, 2004 CNN programming content contained in a block, spanning from 12:20:00 to 12:40:00, whose file is therefore named “CNN-2004006-01-T12:40:00.” In addition, suppose the segment metadata for this segment being processed indicates that the start time of such segment is 12:10:00 and the end time is 12:25:00. Because the block that is being processed only contains programming content from 12:20:00 to the 12:40:00 (and therefore not the beginning portion of the 12:10:00 to 12:25:00 program), content packager 104 will search for another block filename that includes content from the same content provider (i.e., CNN) and a block end time which is later than 12:10:00 (the segment start time)—such as “CNN-2004-06-01-T12:20:00.” Upon identifying this block, content packager 104 copies from this block the programming content segment portion having a start time of 12:10:00 and the end time of 12:20:00 and appends this portion of content to the programming content segment portion having a start time of 12:20:00 and an end time of 12:25:00 of the block named “CNN-2004-06-01-12:40:00,” thereby creating a complete block for storage in storage 113 (step 1314). Of course, if an entire segment is contained within a given block, step 1314 is skipped. It should be noted that when programming content is required from two or more blocks to form a complete segment, in accordance with an embodiment, the programming content from each of these blocks is appended after each of the blocks is formed. In accordance with another embodiment of the invention, a segment comprising programming content from two or more blocks may be formed by appending the relevant programming content from the blocks when all of the programming content for the segment is received—even if one or more of the blocks comprising the relevant programming content have not yet been completely formed.

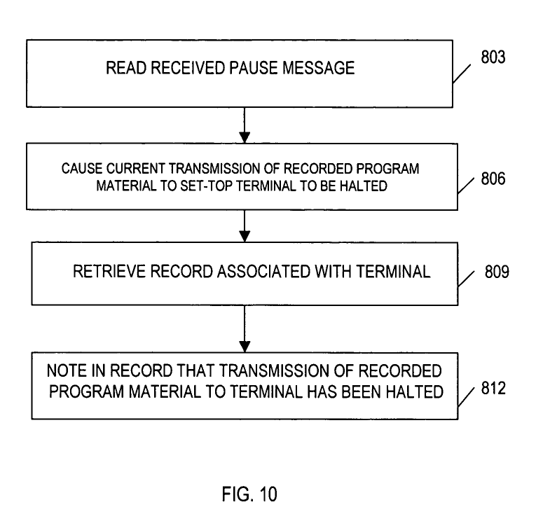

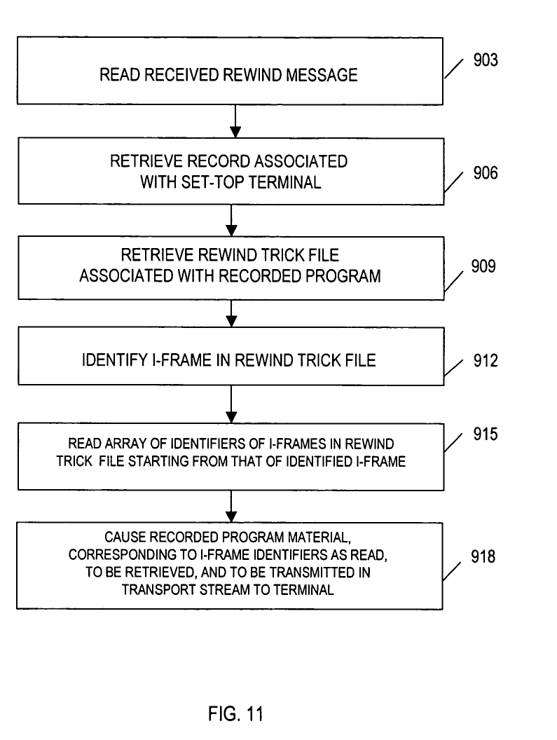

Next, at step 1316, once a segment is formed, the segment metadata relating to the segment programming content is associated thereto, and the segment programming content is made available to one or more users' set top terminals 158-1 to 158-L (step 1318) as described above with reference to FIGS. 2A to 2F above and FIGS. 7 to 9 below. In addition, the manipulation (e.g., pausing, rewinding, fast-forwarding) of program segments is described below with reference to FIGS. 10 to 12.

### Transmission Set-Up, Receiving User Requests, and Transmission of Content

Network controller 125, among others, assigns resources for transporting program materials to set-top terminals and communicates various data including system information with the terminals. Upstream data from a set-top terminal to network controller 125 is communicated via a reverse passband, e.g., 5 to 40 MHz band, of a coaxial cable. The reverse passband comprises reverse data channels (RDCs) having a 1 MHz bandwidth in this instance, through which quaternary phase shift keying (QPSK) signals containing upstream data are transmitted. It should be noted that the 1 MHz bandwidth allocated for an RDC here is for illustrative purposes only. It will be appreciated that a person skilled in the art may allocate other bandwidths therefor depending on the actual implementations. A set-top terminal utilizes an RDC for sending both application data and control messages. For example, the Digital Audio Visual Council (DAVIC), a standard setting organization, has defined a contention-based access mechanism whereby multiple set-top terminals share an RDC. This mechanism enables the set-top terminals to transmit upstream messages without a dedicated connection to a QPSK demodulator. The mechanism also provides equal access to the set-top terminals that share the RDC, and enables detection and recovery from reverse path collisions that occur when two or more of the terminals transmit an upstream message simultaneously. As also specified by DAVIC, for communications purposes, the set-top terminals and network controller 125 are identified by the Internet protocol (IP) addresses assigned thereto. However, these IP addresses may be randomly assigned each time when system 300 is reconfigured. As a result, the IP address of a set-top terminal or controller 125 may change after a system reconfiguration. Nevertheless, each set-top terminal and controller 125 is also assigned a media access control (MAC) address on a permanent basis, surviving any system reconfiguration.

Downstream data from network controller 125 to a set-top terminal is communicated via forward data channels (FDCs). These channels, often referred to as “out-of-band” channels, may occupy the 70 to 130 MHz band of a coaxial cable. QPSK signals containing system messages to a set-top terminal are transmitted through an FDC having a 1 MHz bandwidth in this instance. It should be noted that the 1 MHz bandwidth allocated for an FDC here is for illustrative purposes only. It will be appreciated that a person skilled in the art may allocate other bandwidths therefor depending on the actual implementations.

When a user at a set-top terminal, say, terminal 158-1, turns on the TV associated therewith and selects a particular program channel, say, program channel 2, or change from another channel to channel 2, terminal 158-1 in a well known manner scans for any transport streams transporting programs to the neighborhood. In system 300, each transport stream is identified by a unique transport stream identification (TSID).

Continuing the above example, once the TSIDs of the transport streams are detected, terminal 158-1 sends through QPSK modem pool 127 a request for program channel 2 material. FIG. 7 illustrates one such request (denoted 500) sent from a set-top terminal to network controller 125 via an RDC. As shown in FIG. 7, request 500 includes, among others, destination field 503 which in this instance contains the IP address of network controller 125 to which request 500 is destined; request data field 506 which contains data concerning the detected TSIDs and the requested program channel material, e.g., program channel 2 material in this instance; and origination field 509 which in this instance contains the EP (and/or MAC) address of terminal 158-1 from which request 500 originates.

It should be noted at this point that, in addition to requesting live broadcast programming and initial broadcast programming content through the selection of a channel, a user may also request programming content (including program segments) that has already been broadcast and which is recorded and stored by headend 105. Such recorded programming content may be accessed by, for example, issuing a program selection through an electronic program guide (EPG) or some other GUI configured for the access of programming content for such recorded content from set-top terminal 158 as part of the aforementioned interactive viewing service. In addition, segments of programming content may be made available to users by, e.g., the GUIs of FIGS. 2A to 2F.

A communication protocol used by a set-top terminal for transmitting to headend 105 a selected command to request desired received programming content, and other commands to pause, rewind and fast-forward, is well known in the art, and an example of one such protocol used for such commands is described in “Lightweight Stream Control Protocol,” Time Warner Cable, Ver. 1.0, Jun. 10, 1999.

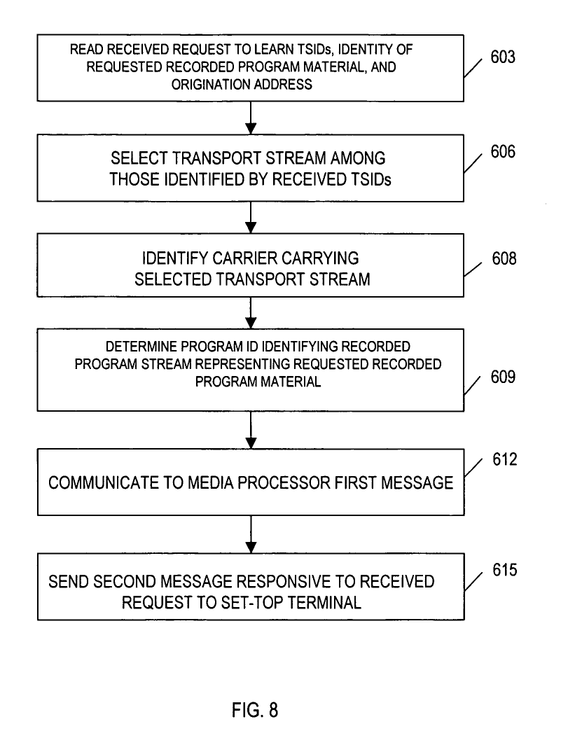

After receiving request 500, network controller 125 reads the received request to learn the TSIDs, the identity of the requested program material, and the origination address therein, as indicated at step 603 in FIG. 8. In response to received request 500, network controller 125 communicates with media processor 119 to determine the capacity required for transmitting the requested program material. Based on the required capacity, controller 125 at step 606 selects a transport stream among those identified by the received TSIDs which is suitable for transporting the requested program material. Controller 125 at step 608 identifies the carrier carrying the selected transport stream.

Referring also to FIG. 3, modulator bank 123 in this instance is located in hub 120 connected to headend 105 via IP transport on the one hand and to HFC cable network 140 on the other hand. Bank 123 includes multiple modulators, each of which is used to modulate transport streams onto different carriers. Each modulated carrier carrying a transport stream is transmitted through a transmission channel associated therewith. FIG. 9 illustrates M carriers, C₁ through C_{M}, associated with M transmission channels in the forward passband. As shown in FIG. 9, the carrier frequency of C₁ is denoted CF₁; the carrier frequency of C₂ is denoted CF₂; . . . ; and the carrier frequency of C_{M} is denoted CF_{M}. In this example, each program stream may contain 4.2 Mb/s video and audio program data. By using a 256-quadrature-amplitude-modulation (256-QAM) technique and 6 MHz transmission channel, each modulator in modulator bank 123 in this instance may modulate up to 9 program streams, multiplexed in a transport stream, onto the corresponding carrier. The resulting modulated carrier is transmitted through the transmission channel associated with the carrier.

Network controller 125 may include therein a carrier assignment table which lists, for each carrier, the TSID of the transport stream carried thereby. The carrier identification by network controller 125 at aforementioned step 608 may be achieved by looking up from the table the carrier associated with the TSID of the selected transport stream. Based on the requested program channel (for a request of a live program) or the requested recorded program identified by a user's command to play such program, network controller 125 at step 609 determines the program ID identifying the program stream representing the requested program material, which is then multiplexed with other program streams in the selected transport stream. At step 612, network controller 125 communicates to media processor 119 a first message containing the identity of the modulator in modulator bank 123 which corresponds to the carrier, say, C1, just determined, and the program ID associated with the requested program material just determined. Network controller 125 at step 615 sends, through QPSK modem pool 127, a second message responsive to the received request to set-top terminal 158-1 identified by the origination IP (and/or MAC) address in field 509 of request 500. This second message traversing an FDC contains the information concerning the carrier frequency, i.e., CF₁ in this instance, to which terminal 158-1 should tune to receive the appropriate transport stream, and the program ID for extracting the desired program stream within the transport stream.

In response to the first message, processor 119 causes a copy of the program stream representing the requested program material thereto to be transmitted downstream and causes the program stream to be multiplexed with any other program streams already in the transport stream identified by the selected TSID. In addition, processor 119 causes media switching unit 117 to switch the resulting transport stream to the modulator corresponding to the carrier C₁. Accordingly, the modulator modulates the carrier C₁ with the received transport stream, and causes transmission of the modulated carrier through the transmission channel associated with CF₁.

Based on the information in the second message, terminal 158-1 tunes to the carrier frequency CF₁ to receive the transmitted transport stream, and extracts therefrom the desired program stream, representing the requested program material in this instance. In a well known manner, terminal 158-1 converts the extracted program stream to appropriate signals for the associated TV to play the requested program material.

While the requested program material is being played, terminal 158-1 continuously registers the last I-frame identifier in the received transport stream. From time to time, terminal 158-1 sends a “heartbeat” containing the IP (and/or MAC) address identifying terminal 158-1 and the last I-frame identifier to media processor 119. Processor 119 keeps, for terminal 158-1, a record identified by the IP (and/or MAC) address of terminal 158-1, and tracks the program being transmitted to terminal 158-1 and its I-frame progress. When processor 119 no longer receives heartbeats from terminal 158-1, e.g., because of an off state of the terminal, processor 119 may cause the transmission of the transport stream to terminal 158-1 to be halted.

### Pause Command

When the user issues a pause command to terminal 158-1, e.g., by pressing a “pause” key on a remote control associated therewith to temporarily stop the progress of the program, terminal 158-1 issues a pause message to media processor 119 identified by its IP address. The process for pausing programming content is described below with reference to FIG. 10. The pause message in this instance includes a pause initiation command, the last I-frame identifier registered by terminal 158-1, and the IP and/or MAC address of terminal 158-1. After issuing the pause message, terminal 158-1 enters a pause state and causes the picture corresponding to the next I-frame, say I-frameₚₐᵤₛₑ, to be frozen on the TV screen, thereby achieving the pause effect. Processor 119 reads the received pause message, as indicated at step 803 in FIG. 10. Processor 119 at step 806 causes the current transmission of the program material to set-top terminal 158-1 (identified by the received EP and/or MAC address) to be halted at the I-frame immediately following the last I-frame identified in the received message. Processor 119 at step 809 retrieves the record associated with terminal 158-1. Processor 119 at step 812 notes in the record that the transmission of the program material to terminal 158-1 has been halted at I-frameₚₐᵤₛₑ.

When the user issues a command to resume viewing the program material, e.g., by toggling the pause key on the remote control, terminal 158-1 exits the pause state, sends a resumption message to processor 119, and readies itself to receive the program material starting from I-frameₚₐᵤₛₑ. This resumption message includes a resumption command, and the EP and/or MAC address of terminal 158-1. Processor 119 then retrieves the record associated with terminal 158-1 identified by the received EP and/or MAC address. In response to the resumption command, processor 119 causes the transmission of the program material to terminal 158-1 to be restarted from I-frameₚₐᵤₛₑ, and notes in the record the transmission resumption event. As a result, terminal 158-1 resumes receiving the program material in the same program stream delivered thereto before. It should be noted that use of a MAC address, instead of an IP address, to identify terminal 158-1 may be advantageous here especially when the pause state is long, so much so that a reconfiguration of system 300 may have occurred during such a state. In that case, the IP address identifying terminal 158-1 before the system reconfiguration may be different than that after the reconfiguration, and as a result, by using only the pre-reconfiguration IP address of terminal 158-1 for its identification, the resuming program stream would not be delivered to the intended terminal 158-1 after the reconfiguration. On the other hand, since the MAC address of terminal 158-1 is immutable and survives any system reconfiguration, by relying on the MAC address of terminal 158-1 for its identification here, the resuming program stream would be correctly delivered to terminal 158-1 even after a system reconfiguration.

### Rewind Command

While viewing a program, the user may issue a rewind command, e.g., by pressing a rewind key on the remote control, to rewind the program. In that case, terminal 158-1 issues a rewind message to processor 119 identified by its IP address. This rewind message includes a rewind initiation command, the last I-frame identifier registered by terminal 158-1, and the IP address (and/or MAC address) identifying terminal 158-1. Processor 119 then reads the received rewind message as indicated at step 903 in FIG. 11. Processor 119 at step 906 retrieves the record associated with set-top terminal 158-1 identified by the received IP address (and/or MAC address). Knowing from the record the identity of the program being transmitted, processor 119 at step 909 retrieves from the aforementioned storage the rewind trick file associated with the program. Based on the last I-frame information in the received message, processor 119 at step 912 identifies the I-frame in the rewind trick file which either matches or is the closest to that last I-frame. Processor 119 at step 915 reads the array of identifiers of the I-frames in the rewind trick file starting from that of the identified I-frame. Processor 119 at step 918 causes the program material, corresponding to the I-frame identifiers as read, to be retrieved from storage (not shown), and to be transmitted in the transport stream to terminal 158-1, thereby achieving the desired rewind effect.

When the user issues a command to stop rewinding the program, e.g., by toggling the rewind key on the remote control, terminal 158-1 sends a rewind termination message to processor 119. This message includes a rewind termination command, and the IP address (and/or MAC address) of terminal 158-1. In response to the rewind termination command, processor 119 stops reading the rewind trick file associated with the program. Processor 119 learns from the record associated with terminal 158-1 the last I-frame identifier read from the rewind trick file. Processor 119 causes retrieval of the program material at the normal forward speed from storage (not shown) starting from the I-frame identified by the last read identifier, and transmission of the retrieved program material to terminal 158-1. As a result, terminal 158-1 resumes receiving the program material at the normal forward speed in the same transport stream.

### Fast-Forward Command

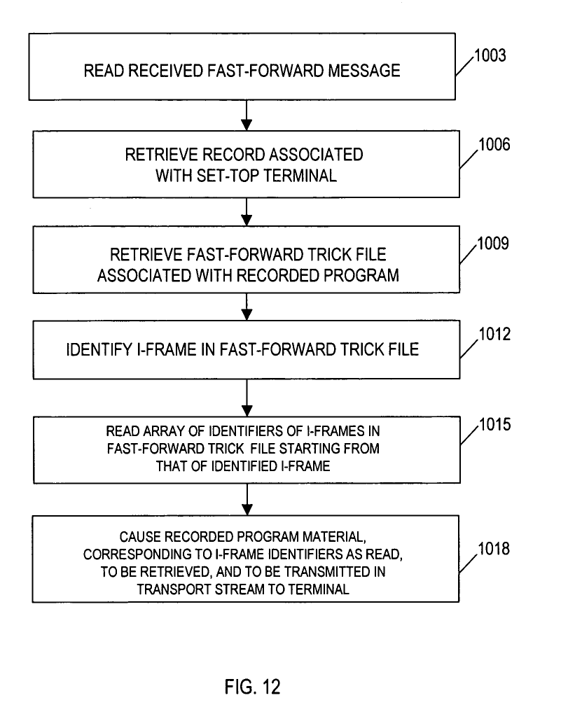

While viewing a recorded program, the user may issue a fast-forward command, e.g., by pressing a fast-forward key on the remote control, to fast-forward the program. In that case, terminal 158-1 issues a fast-forward message to processor 119 identified by its IP address. This fast-forward message includes a rewind initiation command, the last I-frame identifier registered by terminal 158-1, and the IP address (and/or MAC address) identifying terminal 158-1. Processor 119 then reads the received fast-forward message, as indicated at step 1003 in FIG. 12. Processor 119 at step 1006 retrieves the record associated with set-top terminal 158-1 identified by the received IP address (and/or MAC address). Knowing from the record the identity of the program being transmitted, processor 119 at step 1009 retrieves from the aforementioned storage the fast-forward trick file associated with the program. Based on the last I-frame information in the received message, processor 119 at step 1012 identifies the I-frame in the fast-forward trick file which either matches or is the closest to that last I-frame. Processor 119 at step 1015 reads the array of identifiers of the I-frames in the fast-forward trick file starting from that of the identified I-frame. Processor 119 at step 1018 causes the program material, corresponding to the I-frame identifiers as read, to be retrieved from storage (not shown), and to be transmitted in the transport stream to terminal 158-1, thereby achieving the desired fast-forward effect.

When the user issues a command to stop fast-forwarding the program, e.g., by toggling the fast-forward key on the remote control, terminal 158-1 sends a fast-forward termination message to processor 119. This message includes a fast-forward termination command, and the IP address (and/or MAC address) of terminal 158-1. In response to the fast-forward termination command, processor 119 stops reading the fast-forward trick file associated with the program. Processor 119 learns from the record associated with terminal 158-1 the last I-frame identifier read from the fast-forward trick file. Processor 119 causes retrieval of the program material at the normal forward speed from storage (not shown) starting from the I-frame identified by the last read identifier, and transmission of the retrieved program material to terminal 158-1. As a result, terminal 158-1 resumes receiving the program material at the normal forward speed in the same transport stream.

The foregoing merely illustrates the principles of the invention. It will thus be appreciated that those skilled in the art will be able to devise numerous other arrangements which embody the principles of the invention and are thus within its spirit and scope.

For example, system 300 is disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed servers or routers

In addition, the process described above for determining where a segment begins and ends requires that content packager 104 read segment metadata for start time and end time information and then find the appropriate segment content within a block based upon these times. In accordance with an embodiment of the invention, segmentation messages may be used to identify desired programming content for associating metadata thereto and processing the program into segments based upon the associated metadata. In accordance with an aspect of the invention, the TV program streams received by processor 109 and forwarded to buffer 102 may be pre-processed, e.g., by the providers, to include segmentation messages which content packager 104 uses to identify a particular show, movie, etc. In accordance with an embodiment of the invention, the segmentation messages include origin identification information, which is a unique identifier for identifying a particular program in the program stream. In such an embodiment, metadata that is stored by metadata file 1100 may also include origin identification information (not shown). Accordingly, such information stored by a segmentation message associated with a program and also stored by metadata file 1100 may be then be used to correlate or link metadata with a corresponding program. For example, if a metadata file and a segmentation message associated with a program share matching origin identification information, then, in accordance with an embodiment of the invention, content packager 104 may be programmed to associate such metadata file with such program.

In addition, it should be noted that the GUIs illustrated in FIGS. 2A to 2F merely provide one example for displaying to users the availability of segments for interactive viewing, and that many other variations of GUIs may be used.

Finally, the block-dividing technique described above includes forming blocks having twenty minutes of content at normal play time. It should be noted, however, that the size of the block may be greater or smaller than twenty minutes of content and that, in accordance with an embodiment of the invention, the size may depend upon the type of program that is received. For example, a program that is short in duration may be divided into blocks of smaller size than a program that is of a longer duration. In addition, a program type that typically comprises a larger number of segments (e.g., the evening news, wherein each story is deemed a segment) may be divided into blocks of smaller size than a program type that typically comprises smaller number of segments (e.g., a baseball game, wherein each half of an inning is deemed a segment).

What is claimed is:

1. A method for processing a program stream containing at least one program, the at least one program including a plurality of program segments, the method comprising:
receiving the program stream;
dividing the program stream into a plurality of blocks;
identifying one or more of the plurality of blocks relating to a selected one of the program segments; and
deriving, from the identified blocks, content of the selected program segment.

2. The method of claim 1, further comprising:
causing the content of the selected program segment to be available for viewing prior to receiving the program in its entirety.

3. The method of claim 1, wherein the program stream is divided into the plurality of blocks based upon a content amount.

4. The method of claim 3 wherein the content amount is measured by play time of the at least one program.

5. The method of claim 3, further comprising:
identifying at least one program type associated with the at least one program; and
wherein the program stream is divided into the plurality of blocks when the content amount meets a predetermined value, and wherein the predetermined value is based at least upon the at least one program type.

6. The method of claim 1, further comprising:
determining whether a plurality of the identified blocks relate to the selected one of the program segments; and
appending content of one of the identified blocks relating to the selected one of the program segments to content of another of the identified blocks relating to the selected one of the program segments, when a plurality of the identified blocks relate to the selected one of the program segments.

7. The method of claim 1, further comprising:
combining the derived content with additional content relating to the selected program segment;
wherein the additional content is within the program stream and not the plurality of blocks.

8. The method of claim 1, further comprising:
storing each of the plurality of blocks; and
associating a respective filename with each of the plurality of blocks, wherein the respective filename is descriptive of each of the plurality of blocks.

9. The method of claim 8, wherein the filename identifies a source of the received program stream.

10. The method of claim 8, wherein the filename identifies a time that the program stream is received.

11. The method of claim 1, further comprising:
determining whether authorization data is received, the authorization data providing authorization to divide the program stream into the plurality of blocks; and
wherein the program stream is divided into the plurality of blocks if the authorization data is received.

12. A method for allowing interactive viewing of a program segment in a program, the method comprising:
recording a program stream containing the program, the recorded program stream being divided into a plurality of blocks;
storing the plurality of blocks in storage;
associating one or more of the plurality of blocks in storage with the program segment;
deriving, from the associated blocks, content of the program segment; and
making available the content of the program segment for interactive viewing thereof.

13. The method of claim 12, wherein the content of the program segment is made available prior to recording the program in its entirety.

14. The method of claim 12, wherein the program stream is divided into the plurality of blocks based upon a content amount.

15. The method of claim 14, wherein the content amount is measured by a play time of the at least one program.

16. The method of claim 14, further comprising:
identifying a program type associated with the program; and
wherein the program stream is divided into the plurality of blocks when the content amount meets a predetermined value, and wherein the predetermined value is based at least upon the program type.

17. The method of claim 12, further comprising:
determining whether more than one of the associated blocks relate to the program segment; and
appending content of one of the associated blocks relating to the program segment to content of another of the associated blocks relating to the program segment, when more than one of the associated blocks relate to the program segment.

18. The method of claim 12, further comprising:
combining the derived content with additional content relating to the program segment;
wherein the additional content is within the program stream and not the plurality of blocks.

19. The method of claim 12, further comprising:
associating a respective filename with each of the plurality of blocks, wherein the respective filename is descriptive of each of the plurality of blocks.

20. The method of claim 19 wherein the filename identifies a source of the recorded program stream.

21. The method of claim 19, wherein the filename identifies a time that the program stream is recorded.

22. The method of claim 12, further comprising:
determining whether authorization data is received, the authorization data providing authorization to divide the program stream into a plurality of blocks; and
wherein the program stream is divided into the plurality of blocks if the authorization data is received.

23. A system for processing a program stream containing at least one program, the at least one program including a plurality of program segments, the system comprising:
an interface to receive the program stream; and
a processor programmed to:
divide the program stream into a plurality of blocks;
identify one or more of the plurality of blocks relating to a selected one of the program segments; and
derive, from the identified blocks, content of the selected program segment.

24. The system of claim 23, wherein the processor is further programmed to cause the content of the selected program segment to be available for viewing prior to receiving the program in its entirety.

25. The system of claim 23, wherein the program stream is divided into the plurality of blocks based upon a content amount.

26. The system of claim 25, wherein the content amount is measured by play time of the at least one program.

27. The system of claim 25 wherein the processor is further programmed to identify at least one program type associated with the at least one program; and
wherein the program stream is divided into the plurality of blocks when the content amount meets a predetermined value, and wherein the predetermined value is based at least upon the at least one program type.

28. The system of claim 23, wherein the processor is further programmed to:
determine whether more than one of the identified blocks relate to the selected one of the program segments; and
append content of one of the identified blocks relating to the selected one of the program segments to content of another of the identified blocks relating to the selected one of the program segments, when more than one of the identified blocks relate to the selected one of the program segments.

29. The system of claim 23, wherein the processor is further programmed to combine the derived content with additional content relating to the selected program segment;
wherein the additional content is within the program stream and not the plurality of blocks.

30. The system of claim 23, further comprising:
a storage device to store each of the plurality of blocks; and
wherein the processor is further programmed to associate a respective filename with each of the plurality of blocks, wherein the respective filename is descriptive of each of the plurality of blocks.

31. The system of claim 30, wherein the filename identifies a source of the received program stream.

32. The system of claim 30, wherein the filename identifies a time that the program stream is received.

33. The system of claim 23, wherein the processor is further programmed to determine whether authorization data is received, the authorization data providing authorization to divide the program stream into the plurality of blocks; and
wherein the program stream is divided into the plurality of blocks by the processor if the authorization data is received.

34. A system for allowing interactive viewing of a program segment in a program, the system comprising:
a storage device to record a program stream containing the program, the recorded program stream being divided into a plurality of blocks and store the plurality of blocks in storage; and
a processor programmed to:
associate one or more of the plurality of blocks in storage with the program segment;
derive from the associated blocks content of the program segment; and
make available the content of the program segment for interactive viewing thereof.

35. The system of claim 34, wherein the processor is further programmed to make the available content of the program segment for interactive viewing prior to recording the program in its entirety.

36. The method of claim 34, wherein the program stream is divided into the plurality of blocks based upon a content amount.

37. The system of claim 36, wherein the content amount is measured by play time of the at least one program.

38. The system of claim 36, wherein the processor is further programmed to identify a program type associated with the program; and
wherein the program stream is divided into the plurality of blocks when the content amount meets a predetermined value, and wherein the predetermined value is based at least upon the program type.

39. The system of claim 34, wherein the processor is further programmed to determine whether more than one of the associated blocks relate to the program segment, and to append content of one of the associated blocks relating to the program segment to content of another of the associated blocks relating to the program segment, when more than one of the associated blocks relate to the program segment.

40. The system of claim 34, wherein the processor is further programmed to combine the derived content with additional content relating to the program segment;
wherein the additional content is within the program stream and not the plurality of blocks.

41. The system of claim 34, wherein the processor is further programmed to associate a respective filename with each of the plurality of blocks, wherein the respective filename is descriptive of each of the plurality of blocks.

42. The system of claim 41, wherein the filename identifies a source of the recorded program stream.

43. The system of claim 41, wherein the filename identifies a time that the program stream is recorded.

44. The system of claim 34, wherein the processor is further programmed to determine whether authorization data is received, the authorization data providing authorization to divide the program stream into a plurality of blocks; and
wherein the program stream is divided into blocks by the processor if the authorization data is received.
